(19) United States
(12) Patent Application Publication
(10) Pub. No.: US 2006/0206478 A1
(43) Pub. Date: Sep. 14, 2006

(54) Playlist generating methods

(75) Inventors: William T. Glaser, San Francisco, CA (US); Timothy B. Westergren, San Francisco, CA (US); Etienne F. Handman, Dublin, CA (US); Thomas J. Conrad, Oakland, CA (US)

Correspondence Address: BANNER & WITCOFF, LTD., TEN SOUTH WACKER DRIVE, SUITE 3000, CHICAGO, IL, 60606, US

(73) Assignee: Pandora Media, Inc., Oakland, CA (US)

(21) Appl. No.: 11/295,339

(22) Filed: Dec. 6, 2005

Related U.S. Application Data
(63) Continuation-in-part of application No. 10/150,876, filed on May 16, 2002, now Pat. No. 7,003,515.
(60) Provisional application No. 60/291,821, filed on May 16, 2001.

(51) Int. Cl. G06F 17/30; G06F 7/00

(52) U.S. Cl. 707/5

(57) ABSTRACT

Methods of generating a playlist for a user are disclosed. For example, an input seed from the user associated with one or more items in a database is received. The input seed may be a song name or artist name. Characteristics that correspond to the input seed are identified. One or more focus traits based on the characteristics are also identified. Based on the identification of the one or more focus traits, a weighting factor is assigned to at least some of the characteristics. The weighted value of the characteristics that correspond to the input seed and characteristics of items in the database are compared. Based on the comparison, items for the playlist are selected.

This application is a continuation-in-part of U.S. patent application Ser. No. 10/150,876, filed May 16, 2002, and also claims priority to provisional U.S. Patent Application Ser. No. 60/291,821, filed May 16, 2001. The entire disclosures of U.S. patent application Ser. Nos. 10/150,876 and 60/291,821 are hereby incorporated by reference.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE EMBODIMENTS OF THE INVENTION

Embodiments of the invention are directed to methods for generating playlists for one or more users.

### BACKGROUND OF THE EMBODIMENTS OF THE INVENTION

A playlist may, for example, sequence performances of songs for a listener. One way to generate such a playlist is to randomly select songs from a larger library of songs and then sequentially play those songs for the listener. However, such playlists do not take into account whether the songs are from a particular genre or otherwise sound alike. Thus, such playlists may not be pleasing to the ear.

Another way to generate a playlist is to select songs manually. For example, a commercial FM radio station may want a playlist featuring only new “lite rock” songs. Thus, the radio station may review songs by “lite rock” artists and manually select some songs for inclusion in the playlist.

While many music playlists are manually generated by humans, some attempts have been made to automate the generation of music playlists. However, the success of these playlists has been stymied by difficulties with using digital algorithms to analyze “fuzzy” characteristics such as whether a song is a “lite rock” song and whether that “lite rock” song sounds like other “lite rock” songs already in the playlist.

These attempts to automate the generation of music playlists utilize two primary methods. The first method is based on non-musicological meta-data tags, such as genre (e.g. “Lite Rock,” “New Country,” “Modem Rock”), year of release, as well as manually created lists of artists and songs. The second method is based on data obtained by mathematical analysis of a digitized data stream. Such analyses can effectively identify some musicological characteristics such as tempo, energy and timbre mix. However, these methods are blind to the musicological characteristics that a human music programmer or disc jockey would ordinarily take into account. Therefore they produce inferior playlists when compared to those created by humans.

### BRIEF SUMMARY OF EMBODIMENTS OF THE INVENTION

Databases such as the Music Genome Project® capture the results of human analysis of individual songs. The collected data in the database represents measurements of discrete musicological characteristics (e.g., “genes” in the Music Genome Project) that defy mechanical measurement. Furthermore, a matching algorithm has been created that can be used to locate one or more songs that sound alike (e.g., are closely related to a source song or group of songs based on their characteristics and weighted comparisons of these characteristics).

In addition, specific combinations of characteristics (or even a single notable characteristic) have been identified that represent significantly discernable attributes of a song. These combinations are known as “focus traits.” For example, prominence of electric guitar distortion, a four-beat meter, emphasis on a backbeat, and a “I, IV, V” cord progression may be a focus trait because such a combination of characteristics is significantly discernable to a listener. Through analysis by human musicologists, a large number of focus traits have been identified-each based on a specific combination of characteristics.

Embodiments of the invention are directed to methods for generating a playlist for one or more users that involve characteristics and focus traits. For example, in the context of music, one embodiment of the invention includes the steps of receiving an input seed from the user associated with one or more items in a database; identifying characteristics that correspond to the input seed; identifying one or more focus traits based on the characteristics; assigning a weighting factor to at least some of the characteristics based on the identification of the one or more focus traits; comparing the weighted value of the characteristics that correspond to the input seed and characteristics of items in the database; and selecting items for the playlist based on the comparison.

Embodiments of the invention may include numerous other features and advantages.

For example, again in the context of music, the step of assigning may further include assigning an additional weighting factor based on preferences of the user. As another example, the step of comparing may include comparing the difference between characteristics that correspond to the input seed and characteristics of items in the database. Moreover, one or more embodiments of the invention may include the step of providing content to the user in accordance with the playlist.

Other details features and advantages of embodiments of the invention will become apparent with reference to the following detailed description and the figures.

### BRIEF DESCRIPTION OF THE DRAWINGS

FIG. 1 shows a flow diagram overview of a consumer item matching method and system.

FIG. 2 shows a flow diagram of focus trait triggering rules employed in a consumer item matching method and system.

FIG. 3 depicts a relationship between different song candidates.

FIG. 4 is a graph showing a deviation vector.

FIG. 5 graphically depicts a bimodal song group.

FIG. 6 depicts an exemplary operating environment for one or more embodiments of the invention.

FIG. 7 shows a flow diagram for one or more embodiments of the invention.

FIG. 8 shows a flow diagram for one or more embodiments of the “Identify Characteristics” step 704 in FIG. 7.

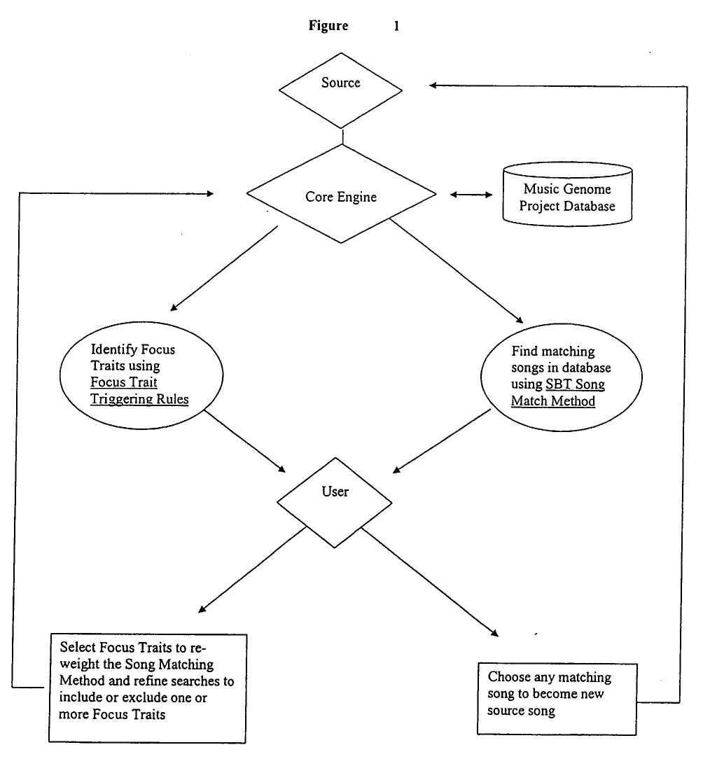

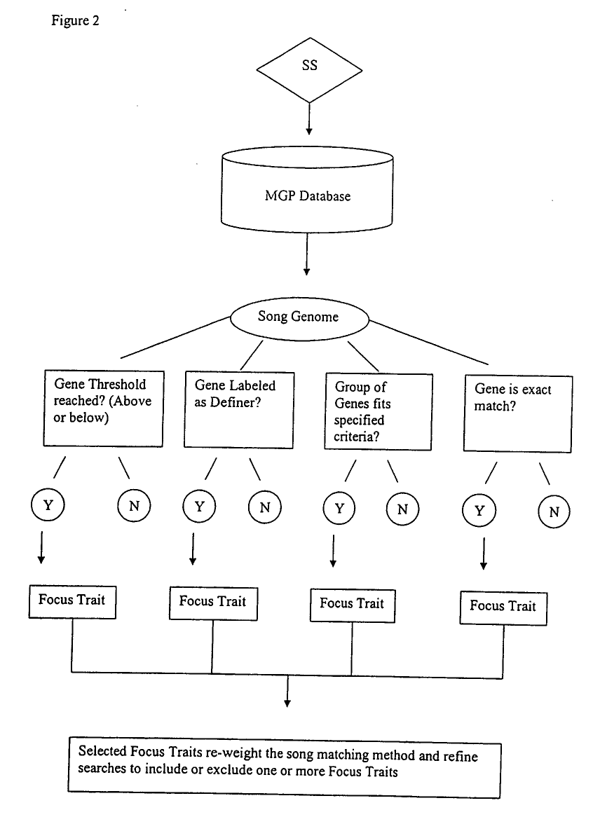

### DETAILED DESCRIPTION OF EMBODIMENTS OF THE INVENTION

One or more embodiments of the invention utilizes the Music Genome Project, a database of songs, in connection with the playlist generating methods. Each song is described by a set of characteristics, or “genes”, or more that are collected into logical groups called “chromosomes.” The set of chromosomes make up the genome. One of these major groups in the genome is the “Music Analysis” Chromosome. This particular subset of the entire genome is sometimes referred to as “the genome.”

Song Matching Techniques

Song to Song Matching

The Music Genome Project® system is a large database of records, each describing a single piece of music, and an associated set of search and matching functions that operate on that database. The matching engine effectively calculates the distance between a source song and the other songs in the database and then sorts the results to yield an adjustable number of closest matches.

Each gene can be thought of as an orthogonal axis of a multi-dimensional space and each song as a point in that space. Songs that are geometrically close to one another are “good” musical matches. To maximize the effectiveness of the music matching engine, we maximize the effectiveness of this song distance calculation.

Song Vector

A given song “S” is represented by a vector containing approximately 150 genes. Each gene corresponds to a characteristic of the music, for example, gender of lead vocalist, level of distortion on the electric guitar, type of background vocals, etc. In a preferred embodiment, rock and pop songs have 150 genes, rap songs have 350, and jazz songs have approximately 400. Other genres of music, such as world and classical, have 300-500 genes. The system depends on a sufficient number of genes to render useful results. Each gene “s” of this vector has a value of an integer or half-integer between 0 and 5. However, the range of values for characteristics may vary and is not strictly limited to just integers or half-integers between 0 and 5.
Song S=(s₁, s₂, s₃, . . . sₙ)

Basic Matching Engine

The simple distance between any two songs “S” and “T”, in n-dimensional space, can be calculated as follows:
distance=square-root of (the sum over all n elements of the genome of (the square of (the difference between the corresponding elements of the two songs)))

This can be written symbolically as:
distance(S, T)=sqrt [(for i=1 to n)Σ(sᵢ−tᵢ)ˆ2]

Because the monotonic square-root function is used in calculating all of these distances, computing the function is not necessary. Instead, the invention uses distance-squared calculations in song comparisons. Accepting this and applying subscript notation, the distance calculation is written in simplified form as:
distance(S, T)=Σ(s−t)ˆ2

Weighted and Focus Matching

Weighted Matching

Because not all of the genes are equally important in establishing a good match, the distance is better calculated as a sum that is weighted according to each gene's individual significance. Taking this into account, the revised distance can be calculated as follows:
distance=Σ[w*(s−t)ˆ2]=[w₁*(s₁−t₁)ˆ2]+[w₂*(s₂−t₂)ˆ2]+ . . .
where the weighting vector “W,”
Song W=(w₁, w₂, w₃, . . . , wₙ)
   is initially established through empirical work done, for example, by a music team that analyzes songs. The weighting vector can be manipulated in various ways that affect the overall behavior of the matching engine. This will be discussed in more detail later in this document.

Scaling Functions

The data represented by many of the individual genes is not linear. In other words, the distance between the values of 1 and 2 is not necessarily the same as the distance between the values of 4 and 5. The introduction of scaling functions f(x) may adjust for this non-linearity. Adding these scaling functions changes the matching function to read:
distance=Σ[w*(f(s)−f(t))ˆ2]

There are a virtually limitless number of scaling functions that can be applied to the gene values to achieve the desired result.

Alternatively, one can generalize the difference-squared function to any function that operates of the absolute difference of two gene values. The general distance function is:
distance=Σ[w*g(|s−t|)]

In the specific case, g(x) is simply x², but it could become X³ for example if it was preferable to prioritize songs with many small differences over ones with a few large ones.

Focus Matching

Focus matching allows the end user of a system equipped with a matching engine to control the matching behavior of the system. Focus traits may be used to re-weight the song matching system and refine searches for matching songs to include or exclude the selected focus traits.

Focus Trait Presentation

Focus Traits are the distinguishing aspects of a song. When an end user enters a source song into the system, its genome is examined to determine which focus traits have been determined by music analysts to be present in the music. Triggering rules are applied to each of the possible focus traits to discover which apply to the song in question. These rules may trigger a focus trait when a given gene rises above a certain threshold, when a given gene is marked as a definer, or when a group of genes fits a specified set of criteria. The identified focus traits (or a subset) are presented on-screen to the user. This tells the user what elements of the selected song are significant.

Focus Trait Matching

An end user can choose to focus a match around any of the presented traits. When a trait, or number of traits, is selected, the matching engine modifies its weighting vector to more tightly match the selection. This is done by increasing the weights of the genes that are specific to the Focus Trait selected and by changing the values of specific genes that are relevant to the Trait. The resulting songs will closely resemble the source song in the trait(s) selected.

Personalization

The weighting vector can also be manipulated for each end user of the system. By raising the weights of genes that are important to the individual and reducing the weights of those that are not, the matching process can be made to improve with each use.

Aggregation

Song to Song Matching

The matching engine is capable of matching songs. That is, given a source song, it can find the set of songs that closely match it by calculating the distances to all known songs and then returning the nearest few. The distance between any two songs is calculated as the weighted Pythagorean sum of the squares of the differences between the corresponding genes of the songs.

Basic Multi-Song Matching

It may also be desirable to build functionality that will return the best matches to a group of source songs. Finding matches to a group of source songs is useful in a number of areas as this group can represent a number of different desirable searches.

The source group could represent the collected works of a single artist, the songs on a given CD, the songs that a given end user likes, or analyzed songs that are known to be similar to an unanalyzed song of interest. Depending on the makeup of the group of songs, the match result has a different meaning to the end user but the underlying calculation should be the same.

This functionality provides a list of songs that are similar to the repertoire of an artist or CD. Finally, it will allow us to generate recommendations for an end user, purely on taste, without the need for a starting song.

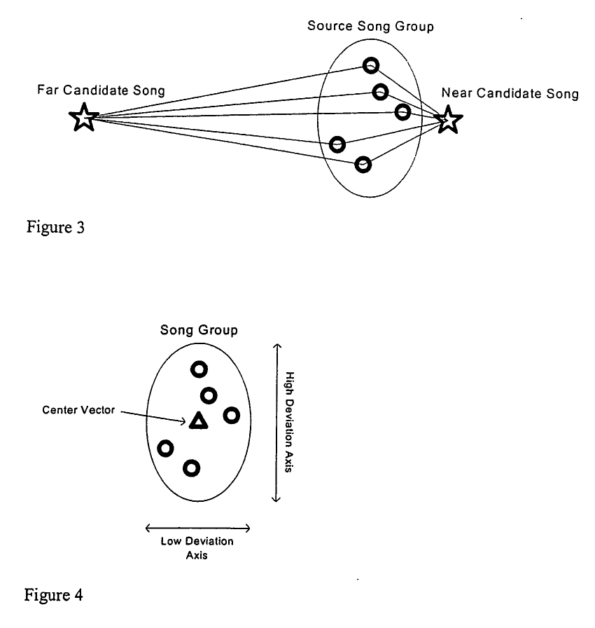

FIG. 3 illustrates two songs. In this Figure, the song on the right is a better match to the set of source songs in the center.

Vector Pairs

Referring to FIG. 4, one way to implement the required calculation is to group the songs into a single virtual song that can represent the set of songs in calculations. The virtual “center” is defined to be a song vector who's genes are the arithmetic average of the songs in the original set. Associated with this center vector is a “deviation” vector that represents the distribution of the songs within the set. An individual gene that has a very narrow distribution of values around the average will have a strong affinity for the center value. A gene with a wide distribution, on the other hand, will have a weak affinity for the center value. The deviation vector will be used to modify the weighing vector used in song-to-song distance calculations. A small deviation around the center means a higher net weighting value.

The center-deviation vector pair can be used in place of the full set of songs for the purpose of calculating distances to other objects.

Raw Multi-Song Matching Calculation

If the assumption is made that a songs gene's are normally distributed and that they are of equal importance, the problem is straightforward. First a center vector is calculated and a standard deviation vector is calculated for the set of source songs. Then the standard song matching method is applied, but using the center vector in place of the source song and the inverse of the square of the standard deviation vector elements as the weights:
Target song vectors T=(t₁, t₂, . . . tₙ)
Center vector of the source group C=(μ₁, μ₂, . . . μₙ)
Standard deviation vector of the source group D=(σ₁, σ₂, . . . σₙ)
   distanceₜ=Σ[(1/σᵢ)ˆ2*(μᵢ−tᵢ)ˆ2]

As is the case with simple song-to-song matching, the songs that are the smallest distances away are the best matches.

Using Multi-Song Matching With the Weighting Vector

The weighting vector that has been used in song-to-song matching must be incorporated into this system alongside the 1/σˆ2 terms. Assuming that they are multiplied together so that the new weight vector elements are simply:
New weight=wᵢ/σᵢˆ2

A problem that arises with this formula is that when σ² is zero the new weight becomes infinitely large. Because there is some noise in the rated gene values, σ² can be thought of as never truly being equal to zero. For this reason a minimum value is added to it in order to take this variation into account. The revised distance function becomes:
distanceₜ=Σ[(wᵢ*0.25/(σᵢˆ2+0.25))*(μᵢ−tᵢ)ˆ2]

Other weighting vectors may be appropriate for multi-song matching of this sort. Different multi-song weighting vector may be established, or the (0.5)² constant may be modified to fit with empirically observed matching results.

Taste Portraits

Groups with a coherent, consistent set of tracks will have both a known center vector and a tightly defined deviation vector. This simple vector pair scheme will breakdown, however, when there are several centers of musical style within the collection. In this case we need to describe the set of songs as a set of two or more vector pairs.

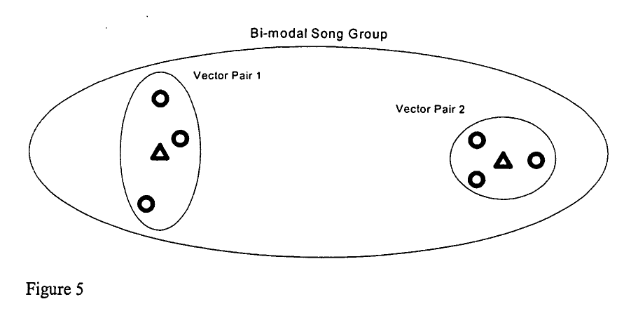

As shown in FIG. 5, the song group can be described with two vector pairs. By matching songs to one OR the other of the vector pairs, we will be able to locate songs that fit well with the set. If we were to try to force all of the songs to be described by a single pair, we would return songs in the center of the large ellipse that would not be well matched to either cluster of songs.

Ideally there will be a small number of such clusters, each with a large number of closely packed elements. We can then choose to match to a single cluster at a time.

In applications where we are permitted several matching results, we can choose to return a few from each cluster according to cluster size.

Playlist Generating Methods

Exemplary Operating Environment

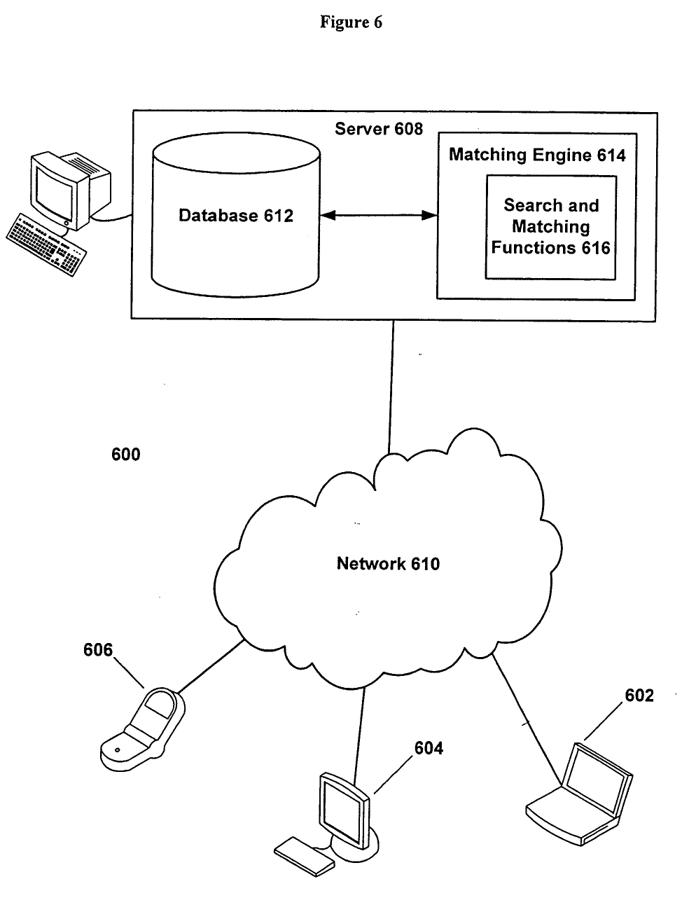

FIG. 6 shows a diagram of exemplary system 600 that may be used to implement embodiments of the invention. A plurality of terminals, such as terminals 602, 604 and 606, couple to server 608 via network 610. Terminals 602, 604 and 606 and server 608, may include a processor, memory and other conventional electronic components and may be programmed with processor-executable instructions to facilitate communication via network 610 and perform aspects of the invention.

One skilled in the art will appreciate that network 610 is not limited to a particular type of network. For example, network 610 may feature one or more wide area networks (WANs), such as the Internet. Network 610 may also feature one or more local area networks (LANs) having one or more of the well-known LAN topologies and may use a variety of different protocols, such as Ethernet. Moreover, network 610 may feature a Public Switched Telephone Network (PSTN) featuring land-line and cellular telephone terminals, or else a network featuring a combination of any or all of the above. Terminals 602, 604 and 606 may be coupled to network 608 via, for example, twisted pair wires, coaxial cable, fiber optics, electromagnetic waves or other media.

In one embodiment of the invention, server 608 contains a database of items 612. Alternatively, Server 608 may be coupled to database of items 612. For example, server 608 may be coupled to a database for the Music Genome Project® system described previously. Server 608 may also contain or be coupled to matching engine 614. Matching engine 614 utilizes an associated set of search and matching functions 616 to operate on the database of items 612. In an embodiment of the invention used with the Music Genome Project® system, for example, matching engine 614 utilizes search and matching functions implemented in software or hardware to effectively calculate the distance between a source song and other songs in the database (as described above), and then sorts the results to yield an adjustable number of closest matches.

Terminals 602, 604 and 606 feature user interfaces that enable users to interact with server 608. The user interfaces may allow users to utilize a variety of functions, such as displaying information from server 608, requesting additional information from server 608, customizing local and/or remote aspects of the system and controlling local and/or remote aspects of the system.

Playlist Generating Method

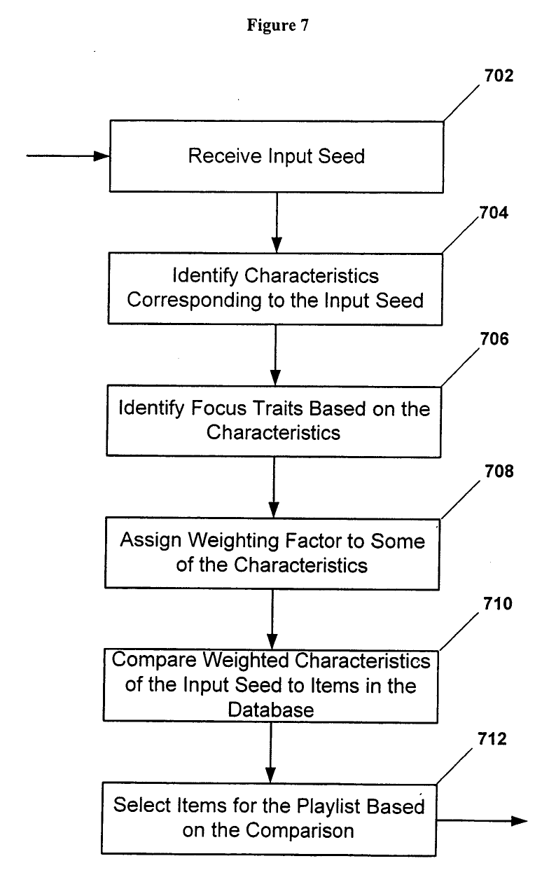

FIG. 7 shows a flow diagram for one embodiment of a playlist generating method 700 that can be executed on, for example, server 608 in FIG. 6. Alternatively, the playlist generating method 700 can be executed exclusively at a stand-alone computer or other terminal.

In “Receive Input Seed” step 702 of FIG. 7, an input seed is received from a user.

The input seed may be a song name such as “Paint It Black” or even a group of songs such as “Paint It Black” and “Ruby Tuesday.” Alternatively, the input seed may be an artist name such as “Rolling Stones.” Other types of input seeds could include, for example, genre information such as “Classic Rock” or era information such as “1960s.” The input seed may be remotely received from a user via, for example, network 610 in FIG. 6. Alternatively, the input seed may be locally received by, for example, being input by a user at a stand-alone computer or other terminal running playlist generating method 700. Terminal 602, 604 or 606 (FIG. 6) may locally maintain all user input and preferences (e.g., in a “user information” database), such as which input seeds have been inputted, or preferences as to how the terminal should visualize any generated playlists. Alternatively, server 608 may remotely maintain all user input and preferences in, for example, a “user information” database having an item corresponding to every user.

In “Identify Characteristics” step 704 of FIG. 7, characteristics that correspond to the input seed are identified. As stated previously, characteristics may include, for example, gender of lead vocalist, level of distortion on the electric guitar, type of background vocals, etc. Characteristics may also include, for example, other types of musicological attributes such as syncopation, which is a shift of accent in a musical piece that occurs when a normally weak beat is stressed. In one or more embodiments of the invention, such characteristics are retrieved from one or more items corresponding to the input seed in a Music Genome Project database.

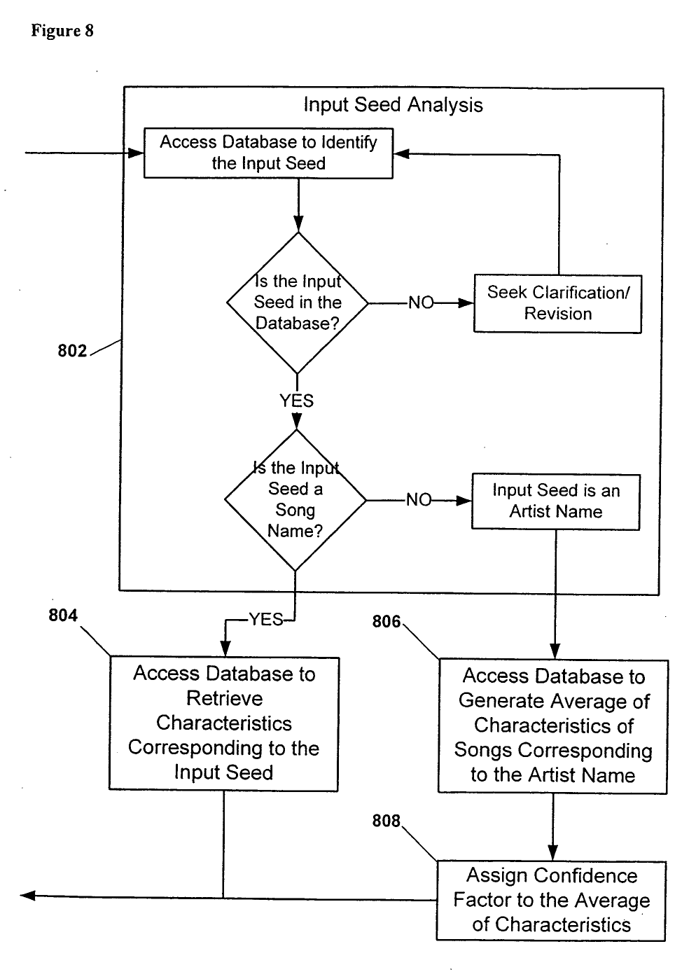

FIG. 8 shows a more detailed flow diagram for one embodiment of the “Identify Characteristics” step 704 (FIG. 7) of playlist generating method 700. As indicated previously, “Identify Characteristics” step 704 as well as all of the other steps in FIG. 7, can be executed on, for example, server 608 in FIG. 6.

In order to identify characteristics corresponding to the input seed, the input seed itself must first be analyzed as shown in “Input Seed Analysis” step 802. Accordingly, database 612 in FIG. 6, which may be a Music Genome Project database, is accessed to first identify whether the input seed is an item in database 612. To the extent the input seed is not an item in the database, the user may be asked for more information in an attempt to determine, for example, whether the input seed was inputted wrong (e.g., “Beetles” instead of “Beatles”) or whether the input seed goes by another name in database (e.g., “I feel fine” instead of “She's in love with me”). Alternatively, close matches to the input seed may be retrieved from the database and displayed to the user for selection.

If the input seed is in the database, the input seed is then categorized. In the embodiment shown in FIG. 8, the input seed is categorized as either a “Song Name” or “Artist Name.” Such categorization is realized by, for example, retrieving “Song Name” or “Artist Name” information associated with the input seed from the database. Alternatively, such categorization is realized by asking the user whether the input seed is a “Song Name” or “Artist Name.”

If the input seed is a song name, then “Retrieve Characteristics” step 804 is executed. In “Retrieve Characteristics” step 804, a song vector “S” that corresponds to the song is retrieved from the database for later comparison to another song vector. As stated previously, in one embodiment the song vector contains approximately 150 characteristics, and may have 400 or more characteristics:
Song S=(s₁, s₂, s₃, . . . , sₙ)

Each characteristic “s” of this vector has a value selected from a range of values established for that particular characteristic. For example, the value of the “syncopation” characteristic may be any integer or half-integer between 0 and 5. As an empirical example, the value of the syncopation characteristic for most “Pink Floyd” songs is 2 or 2.5. The range of values for characteristics may vary and is not limited to just integers or half-integers between 0 and 5.

If the input seed is an artist name, then (in the embodiment of FIG. 8) “Generate Average” step 806 is executed. In one embodiment of “Generate Average” step 806, song vectors S₁ to Sₙ, which each correspond to one of n songs in the database by the artist that is the subject of the input seed, are retrieved. Alternatively, and as stated previously, song vectors S₁ to Sₙ could correspond to one of n songs in the database on a particular album by the artist.

After song vectors S₁ to Sₙ have been retrieved, an average of all values for each characteristic of every song vector S₁ to Sₙ is calculated and populated into a “center” or virtual song vector:
Center vector C=(μ₁, μ₂, . . . μₙ)
   μ₁=(s_{1,1}+s_{2,1}+ . . . s_{n,1})/n

Of course, other statistical methods besides computing an average could be used to populate center vector “C.” Center vector “C” is then used for later comparison to another song vector as a representation of, for example, the average of all songs by the artist. In one embodiment of the invention, center vector “C₁” corresponding to a first artist may be compared to center vector “C₂” corresponding to a second artist.

After song vectors S₁ to Sₙ have been retrieved, “assign confidence factor” step 808 is executed. In “assign confidence factor” step 808, a deviation vector “D” is calculated:
Deviation Vector D=(σ₁, σ₂, . . . σₙ)
   σ₁=sqrt(((s_{1,1}−μ₁)ˆ2+(s_{2,1}−μ₁)ˆ2+(s_{n,1}−μ₁)ˆ2)/(n−1))
   that shows how similar or dissimilar are the characteristics among each of song vectors S₁ to Sₙ. While one embodiment of the invention contemplates populating the deviation vector by determining the standard deviation of all values for each characteristic of every song vector S₁ to Sₙ, other statistical methods could also be used. As an empirical example of the use of standard deviation to calculate the deviation vector, the value of the syncopation characteristic for most “Pink Floyd” songs is 2 or 2.5, which results in a smaller standard deviation value (e.g., 0.035) than if a standard deviation value were calculated for a characteristic having more divergent values (e.g., if the value of the syncopation characteristic for all songs by Pink Floyd was more widely dispersed between 0 and 5).

To the extent a standard deviation value for a certain characteristic is larger, the averaged value of that characteristic in the virtual song vector is considered to be a less reliable indicator of similarity when the virtual song vector is compared to another song vector. Accordingly, as indicated previously, the values of the deviation vector serve as “confidence factors” that emphasize values in the virtual song vector depending on their respective reliabilities. One way to implement the confidence factor is by multiplying the result of a comparison between the center vector and another song vector by the inverse of the standard deviation value. Thus, for example, the confidence factor could have a value of 0.25/(σᵢˆ2+0.25). The “0.25” is put into the equation to avoid a mathematically undefined result in the event σᵢˆ2 is 0 (i.e., the confidence factor avoids “divide by zero” situations).

Returning to FIG. 7, “Identify Focus Traits” step 706 identifies focus traits based on the values of characteristics of song vector (or virtual song vector) S. As stated previously, focus traits are specific combinations of characteristics (or even a single notable characteristic) representing significantly discernable attributes of a song. As such, focus traits are the kernel of what makes one song actually sound different, or like, another song. Focus traits may be created and defined in many ways, including by having trained musicologists determine what actually makes one song sound different from another, or else having users identify personal preferences (e.g., receiving input from a user stating that he/she likes songs with male lead vocals). Exemplary focus traits include “male lead vocal” or “Middle Eastern influence.” There can be 1, 10, 1000 or more than 1000 focus traits, depending on the desired complexity of the system.

In one embodiment of the invention, a set of rules known as “triggers” is applied to certain characteristics of song vector S to identify focus traits. For example, the trigger for the focus trait “male lead vocal” may require the characteristic “lead vocal present in song” to have a value of 5 on a scale of 0 to 5, and the characteristic ”gender” to also have a value of 5 on a scale of 0 to 5 (where “0” is female and “5” is male). If both characteristic values are 5, then the “male lead vocal” focus trait is identified. This process is repeated for each focus trait. Thereafter, any identified focus traits may be presented to the user through the user interface.

Now that focus traits have been identified, “Weighting Factor Assignment” step 708 is executed. In “weighting factor assignment” step 708, comparative emphasis is placed on some or all of focus traits by assigning “weighting factors” to characteristics that triggered the focus traits. Alternatively, “weighting factors” could be applied directly to certain characteristics.

Accordingly, musicological attributes that actually make one song sound different from another are “weighted” such that a comparison with another song having those same or similar values of characteristics will produce a “closer” match. In one embodiment of the invention, weighting factors are assigned based on a focus trait weighting vector W, where w₁, w₂ and wₙ correspond to characteristics s₁, s₂ and sₙ of song vector S.
Weighting Vector W=(w₁, w₂, W₃, . . . , wₙ)

In one embodiment of the invention, weighting vector W can be implemented into the comparison of songs having and song vectors “S” and “T” by the following formula:
distance(W, S, T)=Σw*(s−t)ˆ2

As described previously, one way to calculate weighting factors is through scaling functions. For example, assume as before that the trigger for the focus trait “male lead vocal” requires the characteristic “lead vocal present in song” to have a value of 5 on a scale of 0 to 5, and the characteristic “gender” to also have a value of 5 on a scale of 0 to 5 (where “0” is female and “5” is male).

Now assume the song “Yesterday” by the Beatles corresponds to song vector S and has an s₁ value of 5 for the characteristic “lead vocal present in song” and an s₂ value of 5 for the characteristic “gender.” According to the exemplary trigger rules discussed previously, “Yesterday” would trigger the focus trait “male lead vocal.” By contrast, assume the song “Respect” by Aretha Franklin corresponds to song vector T and has a t₁ value of 5 for the characteristic “lead vocal present in song” and a t₂ value of 0 for the characteristic “gender.” These values do not trigger the focus trait “male lead vocal” because the value of the characteristic “gender” is 0. Because a focus trait has been identified for characteristics corresponding to s₁ and s₂, weighting vector W is populated with weighting factors of, for example, 100 for w₁ and w₂. Alternatively, weighting vector W could receive different weighting factors for w₁ and w₂ (e.g., 10 and 1000, respectively).

In “Compare Weighted Characteristics” step 710, the actual comparison of song vector (or center vector) S is made to another song vector T. Applying a comparison formula without a weighting factor, such as the formula distance(S, T)=(s−t)ˆ2, song vectors S and T would have a distance value of (s₁−t₁)ˆ2+(s₂−t₂)ˆ2, which is (5-5)ˆ2+(5-0)ˆ2, or 25. In one embodiment of the invention, a distance value of 25 indicates a close match.

By contrast, applying a comparison formula featuring weighting vector W produces a different result. Specifically, the weighting vector W may multiply every difference in characteristics that trigger a particular focus trait by 100. Accordingly the equation becomes w₁(s₁−t₁)ˆ2+w₂(s₂−t₂)ˆ2, which is 100(5-5)ˆ2+100(5-0)ˆ2, or 2500. The distance of 2500 is much further away than 25 and skews the result such that songs having a different gender of the lead vocalist are much less likely to match. By contrast, if song vector T corresponded to another song that did trigger the focus trait “male lead vocal” (e.g., it is “All I Want Is You” by U2), then the equation becomes 100(5-5)ˆ2+100(5-5)ˆ2, or 0, indicating a very close match.

As another example of one embodiment of the invention, a weighting vector value of 1,000,000 in this circumstance would effectively eviscerate any other unweighted matches of characteristics and means that, in most circumstances, two songs would never turn up as being similar.

As indicated previously, it is also possible for one or more values of the weighting vector to be assigned based on preferences of the user. Thus, for example, a user could identify a “male lead vocal” as being the single-most important aspect of songs that he/she prefers. In doing so, a weighting vector value of 10,000 may be applied to the comparison of the characteristics associated with the “male lead vocal” focus trait. As before, doing so in one embodiment of the invention will drown out other comparisons.

In one embodiment of the invention, one weighting vector is calculated for each focus trait identified in a song. For example, if 10 focus traits are identified in a song (e.g., “male lead vocalist” and 9 other focus traits), then 10 weighting vectors are calculated. Each of the 10 weighting vectors is stored for potential use during “Compare Weighted Characteristics” step 710. In one embodiment of the invention, users can select which focus traits are important to them and only weighting vectors corresponding to those focus traits will be used during “Compare Weighted Characteristics” step 710. Alternatively, weighting vectors themselves could be weighted to more precisely match songs and generate playlists.

In “Select Items” step 712, the closest songs are selected for the playlist based on the comparison performed in “Compare Weighted Characteristics” step 710. In one embodiment of the invention, the 20 “closest” songs are preliminary selected for the playlist and placed into a playlist set. Individual songs are then chosen for the playlist. One way to choose songs for the playlist is by random selection. For example, 3 of the 20 songs can be randomly chosen from the set. In one embodiment of the invention, another song by the same artist as the input seed is selected for the playlist before any other songs are chosen from the playlist. One way to do so is to limit the universe of songs in the database to only songs by a particular artist and then to execute the playlist generating method.

To the extent a set of weighted song vectors was obtained, a plurality of sets of closest songs are obtained. For example, if a song has 10 focus traits and the 20 closest songs are preliminarily selected for the playlist, then 10 different sets of 20 songs each (200 songs total) will be preliminarily selected. Songs can be selected for the playlist from each of the sets by, for example, random selection. Alternatively, each set can have songs be selected for the playlist in order corresponding to the significance of a particular focus trait.

As an alternative, or in addition to, randomly selecting songs for the playlist, rules may be implemented to govern the selection behavior. For example, aesthetic criteria may be established to prevent the same artist's songs from being played back-to-back after the first two songs, or to prevent song repetition within 4 hours.

Moreover, regulatory criteria may be established to comply with, for example, copyright license agreements (e.g., to prevent the same artist's songs from being played more than 4 times in 3 hours). To implement such criteria, a history of songs that have been played may be stored along with the time such songs were played.

Accordingly, songs are selected for the playlist from one or more playlist sets according to random selection, aesthetic criteria and/or regulatory criteria. To discern the actual order of songs in the playlist, focus traits can be ranked (e.g., start with all selected songs from the playlist set deriving from the “male lead vocal” focus trait and then move to the next focus trait). Alternatively, or in addition, the user can emphasize or de-emphasize particular playlist sets. If, for example, a user decides that he/she does not like songs having the focus trait of “male lead vocal,” songs in that playlist set can be limited in the playlist.

A number of songs are selected from the Set List and played in sequence as a Set.

Selection is random, but limited to satisfy aesthetic and business interests, (e.g. play duration of a particular range of minutes, limits on the number of repetitions of a particular Song or performing artist within a time interval). A typical Set of music might consist of 3 to 5 Songs, playing for 10 to 20 minutes, with sets further limited such that there are no song repetitions within 4 hours and no more than 4 artist repetitions within 3 hours.

After songs have been selected for the playlist, content may be provided to the user in accordance with the playlist. In one embodiment of the invention, content is provided to the user through, for example, network 610 in FIG. 6 or some other form of broadcast medium. Such provision of content may be in the form of content streamed in real time or else downloaded in advance in ways that are known to one of ordinary skill in the art. As another example, content is provided directly to portable or fixed digital media players.

The invention has been described with respect to specific examples including presently preferred modes of carrying out the invention. Those skilled in the art will appreciate that there are numerous variations and permutations of the above described systems and techniques, for example, that would be used with videos, wine, films, books and video games, that fall within the spirit and scope of the invention as set forth in the appended claims.

We Claim:

1. A method of generating a playlist for a user, comprising:
receiving an input seed from the user associated with one or more items in a database;
identifying characteristics that correspond to the input seed;
identifying one or more focus traits based on the characteristics;
assigning a weighting factor to at least some of the characteristics based on the identification of the one or more focus traits;
comparing the weighted value of the characteristics that correspond to the input seed and characteristics of items in the database; and
selecting items for the playlist based on the comparison.

2. The method of claim 1 wherein the input seed is a song name.

3. The method of claim 1 wherein the input seed is an artist name.

4. The method of claim 3 wherein the step of identifying characteristics includes generating an average of characteristics of items in the database.

5. The method of claim 4 wherein the step of identifying characteristics further includes assigning a confidence factor to the average of characteristics of items in the database.

6. The method of claim 1 wherein the step of assigning includes assigning an additional weighting factor based on preferences of the user.

7. The method of claim 1 wherein the step of comparing includes comparing the difference between characteristics that correspond to the input seed and characteristics of items in the database.

8. The method of claim 1 wherein the step of selecting includes generating one or more subsets of items in the database associated with the one or more focus traits.

9. The method of claim 8 wherein the step of selecting further includes choosing items for selection from the one or more subsets of items based on aesthetic or regulatory criteria.

10. The method of claim 1 further comprising the step of providing content to the user in accordance with the playlist.

11. The method of claim 10 wherein the step of providing includes streaming the content to the user through a computer network.

12. A computer-readable medium having computer-executable instructions for performing steps comprising:
receiving an input seed from the user associated with one or more items in a database;
identifying characteristics that correspond to the input seed;
identifying one or more focus traits based on the characteristics;
assigning a weighting factor to at least some of the characteristics based on the identification of the one or more focus traits;
comparing the weighted value of the characteristics that correspond to the input seed and characteristics of items in the database; and
selecting items for the playlist based on the comparison.

13. The computer-readable medium of claim 12 wherein the input seed is a song name.

14. The computer-readable medium of claim 12 wherein the input seed is an artist name.

15. The computer-readable medium of claim 14 wherein the step of identifying characteristics includes generating an average of characteristics of items in the database.

16. The computer-readable medium of claim 15 wherein the step of identifying characteristics further includes assigning a confidence factor to the average of characteristics of items in the database.

17. The computer-readable medium of claim 12 wherein the step of assigning includes assigning an additional weighting factor based on preferences of the user.

18. The computer-readable medium of claim 12 wherein the step of comparing includes comparing the difference between characteristics that correspond to the input seed and characteristics of items in the database.

19. The computer-readable medium of claim 12 wherein the step of selecting includes generating one or more subsets of items in the database associated with the one or more focus traits.

20. The computer-readable medium of claim 19 wherein the step of selecting further includes randomly choosing items for selection from the one or more subsets of items based on aesthetic or regulatory criteria.

21. The computer-readable medium of claim 12 further comprising the step of providing content to the user in accordance with the playlist.

22. The computer-readable medium of claim 12 wherein the step of providing includes streaming the content to the user through a computer network.

23. A method of receiving content corresponding to items in a database, comprising:
providing an input seed associated with one or more items in the database;
receiving a playlist of items in the database based on a comparison of weighted values of characteristics that correspond to the input seed and characteristics of items in the database; and
receiving content in accordance with the playlist.

24. The method of claim 23 wherein the input seed is a song name.

25. The method of claim 23 wherein the input seed is an artist name.

26. The method of claim 23 wherein the step of comparing includes comparing the difference between characteristics that correspond to the input seed and characteristics of items in the database.

27. The method of claim 23 wherein the step of receiving content includes receiving a stream of content through a computer network.
